(19) United States
(12) Patent Application Publication
(10) Pub. No.: US 2005/0001558 A1
(43) Pub. Date: Jan. 6, 2005

(54) Ballast circuit arrangement for operating a discharge lamp with end of lamp life detection

(76) Inventors: Arnold Willem Buij, Eindhoven (NL); Antonius Henricus Peterus Johannes Habraken, Eindhoven (NL); Geert Willem Van Der Veen, Eindhoven (NL)

Correspondence Address: Philips Electronics North America Corporation;Corporate Patent Counsel, PO Box 3001, Briarcliff Manor, NY, 10510, US

(21) Appl. No.: 10/494,606

(22) PCT Filed: Oct. 24, 2002
(86) PCT No.: PCT/IB02/04460

(30) Foreign Application Priority Data
Nov. 7, 2001 (EP) 01204275.0

(51) Int. Cl. H05B 41/36; H05B 37/02

(52) U.S. Cl. 315/224; 315/209 R; 315/219

(57) ABSTRACT

End of life of a lamp operated by a ballast circuit is detected by detecting whether the amplitude of a DC current through the lamp is outside of a range between two predetermined boundary values.

Ballast circuit arrangement for operating a discharge lamp with end of lamp life detection The invention relates to a ballast circuit arrangement for operating a discharge lamp, in particular a fluorescent lamp of the TL type, in which the discharge lamp is included in an AC circuit whereby an alternating current is supplied to the lamp in the normal operational phase thereof, during which an arc discharge takes place continually in the lamp, and in which the lamp is also included in a DC circuit with a comparatively high DC resistance, while detection means are present for detecting a direct current flowing through the DC circuit.

Such a ballast circuit arrangement is known from WO 96/30983. The detection means therein serve to detect the presence or absence of the lamp.

The present invention addresses the problem of how to detect the approach of the end of life of the lamp (denoted with the acronym EOLL, End Of Lamp Life).

According to the invention, a solution is provided to said problem by means of a ballast circuit arrangement of the kind mentioned in the opening paragraph which is characterized in that said detection means are designed for laying down two boundary values for the lamp direct current, the range between said boundary values representing an admissible range for the lamp direct current and the ranges outside said boundary values representing inadmissible ranges for the lamp direct current, and said detection means are further designed for providing an indicator signal for indicating the range in which the lamp direct current is located.

The invention is based on the recognition that the lamp direct current in said DC circuit contains information not only on the presence and absence of the lamp, which is a binary information of the 1/0 type, but that this direct current in fact contains a continuous or analog information on lamp properties such as the approaching end of lamp life, as the inventors have found.

The EOLL condition involves a possible fire hazard or a fusion of the lamp-connection member owing to an excessive dissipation in the electrode region. It would seem to be desirable, therefore, to signal the EOLL in time. The EOLL causes a different lamp resistance during the positive and negative half cycles of the AC supply, which exerts a rectifying effect on said alternating current, so that the level of the lamp direct current changes in the one or the other direction with respect to the value the lamp direct current has in the case of a full symmetry and which is defined by the DC voltage across and the resistance of said DC circuit (which resistance is set for a comparatively high value).

Although there are alternative methods of detecting the EOLL, such as monitoring the lamp voltage/current, the incandescent wire current, etc., the present solution according to the invention offers the advantage that it can be applied in a simple manner to ballast circuit arrangements fitted with a dimmer control. In this case, in fact, the lamp resistance will vary with the adjusted lamp power, said resistance falling steeply with lamp power. The invention can take this into account in a simple manner in that said boundary values bounding the admissible range for the lamp current are made to vary in dependence on the adjustment of the dimmer control.

If the lamp direct current starts to deviate from a nominal value set somewhere (centrally) in the admissible range, this effect can be detected over a long time interval (minutes) through a calculation of a long-term average of the lamp current, so as to increase the reliability of the detection method.

The invention will be explained in more detail below with reference to the drawing, in which:

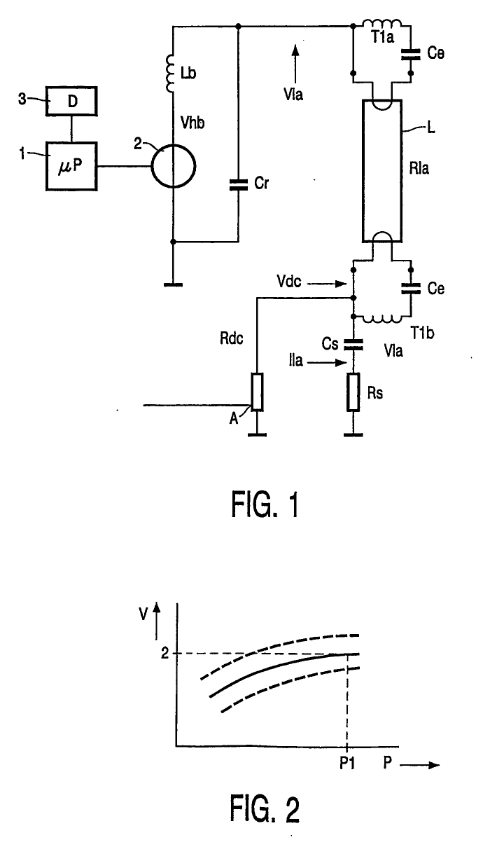

FIG. 1 is a diagram of a ballast circuit arrangement for a TL lamp, in which details not necessary for understanding the invention have been omitted, and

FIG. 2 is a diagram showing the gradient of the boundary values when a dimmer control is used.

The ballast circuit arrangement of FIG. 1 comprises a supply source of the half-bridge commutator type controlled by a control circuit 1, generating a square-wave Vhb with a base frequency of, for example, 45 kHz and with a peak-to-peak value Vdd (410 V), so that in fact a square-wave AC supply voltage is provided which is superimposed on a DC voltage of Vdd/2, where Vdd is the DC supply voltage of the source 2.

The lamp L is connected to the supply source 2 via an adapter circuit Lb (2 mH)-Cr (3 nF). A transformer T1 (not shown) supplies incandescent wire currents via its secondary windings T1a and T1b in a known manner, which currents are stabilized by capacitors Ce in a known manner.

The lamp is furthermore included in a DC circuit with a resistance Rdc to ground. The resistance Rdc has a high value (150 Ω) and is connected between the junction point Vdc and ground.

A capacitor Cs branches off the lamp alternating current through a resistor Rs (0.5 Ω) of very low value, which may serve for monitoring the lamp alternating current Ila.

The DC voltage at the junction point Vdc is normally approximately Vdd/2, because the lamp resistance Rla is normally much lower than Rdc. The lamp direct current flowing through the lamp L while the lamp is on, caused by the average DC voltage Vdd/2 of the supply source 2, is converted by the resistor Rdc into a voltage Vdc=Vdd/2 across the resistor Rdc.

A divided voltage derived from a tap A of the resistor Rdc, for example in a ratio of 1:100, which will then be approximately 2 V in the normal operational state of the lamp, i.e. Vdd/2.100, is supplied to the control circuit 1 which is constructed, for example, as a microcontroller or microprocessor. The latter compares the divided voltage with two boundary values which are set on either side of the nominal value of 2 V and which were empirically determined to a value which, if exceeded by the divided voltage, would indicate that the EOLL condition has established itself, i.e. the divided voltage has left the admissible region situated between the boundary values. In the example given here, the boundary values might be set for 1.5 V and 2.5 V.

When said divided voltage exceeds a boundary value, coming from the admissible range between the boundary values, the control circuit 1 may be programmed so as to provide an indicator signal for indicating the EOLL. This may be done in an even more reliable manner in that not the instantaneous value of the divided voltage, but a value of the divided voltage averaged over a longer period, i.e. a long-term average, is used as a basis for this, so that sporadic or intermittently occurring phenomena leading to an asymmetry of the lamp resistance will have no effect, and there is accordingly a greater certainty that the EOLL condition has established itself.

The measures according to the invention described above plus some additions can be used to particular advantage when a dimmer control (3, FIG. 1) is present, in which case the control circuit 1 controls the power supplied to the lamp by the supply source 2 in dependence on the dimmer control 3. The lamp resistance Rla will then decrease with an increasing power and increase with a decreasing power, and the divided voltage mentioned above and supplied to the control circuit 1 will show a gradient which is a function of the power P of the lamp, as is diagrammatically shown with a full line in FIG. 2.

In the example discussed above, the divided voltage will be, for example, 2 V at a power P1 of the lamp, and the admissible range will extend, for example, from 1.5 V to 2.5 V. Now if the admissible range is made to vary along with the lamp power in a simple manner, the setting of the dimmer control can be taken into account in the detection of the EOLL. The varying boundary values of the-admissible range are diagrammatically shown in broken lines in FIG. 2.

It will be obvious that the practical examples given above of voltages, etc., are merely illustrative and that the invention is by no means limited thereto. It is furthermore deemed to lie within the powers of those skilled in the art to program the control circuit 1 suitably in accordance with the instructions given, in a fixed or variable manner.

Summarizing, it may be stated that the invention offers a very simple and reliable EOLL detection, also if a dimmer control is present.

1. A ballast circuit arrangement for operating a discharge lamp, in which the discharge lamp is included in an AC circuit whereby an alternating current is supplied to the lamp in the normal operational phase thereof, during which an arc discharge takes place continually in the lamp, and in which the lamp is also included in a DC circuit with a comparatively high DC resistance, while detection means are present for detecting a direct current flowing through the DC circuit, characterized in that said detection means are designed for laying down two boundary values for the lamp direct current, the range between said boundary values representing an admissible range for the lamp direct current and the ranges outside said boundary values representing inadmissible ranges for the lamp direct current, and said detection means are further designed for providing an indicator signal for indicating the range in which the lamp direct current is located.

2. A ballast circuit arrangement as claimed in claim 1 and provided with a dimmer control, characterized in that the detection means are designed for varying said boundary values in dependence on the setting of the dimmer control.

3. A ballast circuit arrangement as claimed in claim 1 or 2, characterized in that the detection means are designed for determining the long-term average of the lamp direct current and for providing an indicator signal for indicating the range within which the long-term average of the lamp direct current is situated.
